(19) United States
(12) Patent Application Publication
(10) Pub. No.: US 2007/0011017 A1
(43) Pub. Date: Jan. 11, 2007

(54) Custom-manufactured product delivery option system and method

(75) Inventor: Andrew S. Field, Emigrant, MT (US)

Correspondence Address: Min (Amy) S. Xu, Esq.;DORSEY & WHITNEY LLP, Intellectual Property Department, 50 South Sixth Street, Suite 1500, Minneapolis, MN, 55402-1498, US

(73) Assignee: Printingforless.com

(21) Appl. No.: 11/178,670

(22) Filed: Jul. 11, 2005

(51) Int. Cl. G06Q 99/00; G05B 19/418; G06F 9/46

(52) U.S. Cl. 705/1; 705/8

(57) ABSTRACT

A system and method are provided for dynamically modifying production speed, shipment options and/or creating multiple shipments from an original custom-manufactured product order, with different quantities, shipping methods and/or destinations, and automatically calculating the resulting prices and estimated delivery dates with the modification before the modification is submitted.

### FIELD OF THE INVENTION

The present invention relates generally to a system and method for handling modifications to production speed and shipment options for a custom-manufactured product order, and more particularly, to a system and method capable of modifying production speed and shipment options and creating multiple shipments that have different shipping methods and/or destinations while calculating the resulting prices and estimated delivery dates.

### BACKGROUND OF THE INVENTION

Customers often require changes to production speed and shipment options to meet their required delivery dates and/or shipment destinations for their custom-manufactured product orders. Some may require multiple shipments so that partial quantities of the number of products ordered are sent by different shipping methods and/or to different destinations. In requesting these changes, the customers desire to instantaneously obtain the adjusted cost and estimated delivery dates associated with modifying production speed or shipment options, including creating multiple shipments for certain product quantities with different shipment methods and/or destinations.

Therefore, there is a need for a system and method capable of dynamically modifying production speed and/or shipment options and creating multiple shipments with different shipping methods and/or destinations, as well as automatically calculating and displaying the resulting prices and estimated delivery dates.

### SUMMARY OF THE INVENTION

The present invention provides a system and method of dynamically modifying production speed; shipment options and/or creating multiple shipments from one original shipment, with different quantities, shipping methods and/or destinations, and automatically calculating the resulting prices and estimated delivery dates with the new shipment options.

In one embodiment of the present invention, the method includes: a process whereby a customer can modify a shipping method and/or destination for an existing shipment; and a process that automatically calculates and displays the change in price and the estimated delivery date for the new shipment options before changes are submitted.

In a second embodiment of the present invention, the method includes: a process whereby a customer can split their order into multiple shipments for delivery of specified quantities via different shipping methods or to different destinations; and a process that automatically calculates the sum of all shipment quantities to ensure it equals the total order quantity; and a process that automatically calculates and displays the change in price and the estimated delivery dates for the multiple shipments before new shipments are submitted.

In a third embodiment of the present invention, the method includes: a process whereby a customer can modify the production speed for their custom-manufactured order; and a process that automatically calculates and displays the change in price and the estimated delivery date for the new production speed option before changes are submitted.

In a fourth embodiment of the present invention, the method includes: a process whereby the order's estimated delivery date is dynamically calculated based on the combination of production speed, shipping method and shipping destination options; and a process that dynamically displays the change in price and the estimated delivery date before changes are submitted.

These and other features and advantages of the present invention will become apparent to those skilled in the art from the following detailed description, wherein it is shown and described illustrative embodiments of the invention, including best modes contemplated for carrying out the invention. As it will be realized, the invention is capable of modifications in various obvious aspects, all without departing from the spirit and scope of the present invention. Accordingly, the drawings and detailed description that follow are to be regarded as illustrative in nature and not restrictive.

### BRIEF DESCRIPTION OF THE DRAWINGS

FIG. 1 illustrates a flow chart of one exemplary method of dynamically modifying the delivery options of a custom-manufactured product, including production speed, shipping method, shipping destination and/or creating split shipments, while automatically calculating and displaying the resulting price and estimated delivery date, in accordance with the principles of the present invention.

FIGS. 2A and 2B illustrate before and after screen displays, respectively, of one exemplary method of dynamically modifying the shipping method of an existing shipment while automatically calculating the resulting price and estimated delivery date, in accordance with the principles of the present invention.

FIG. 3 illustrates a screen display of one exemplary method of dynamically modifying the shipping destination of an existing shipment, in accordance with the principles of the present invention.

FIG. 4 illustrates a screen display of one exemplary method of dynamically creating multiple shipments from one original shipment with specified quantities and different shipping methods and/or destinations, while automatically calculating and displaying the resulting price and estimated delivery dates.

FIG. 5 illustrates a screen display of one exemplary method of either specifying a new shipping destination address or selecting an existing address from the customer's account in the database for a newly created split shipment.

FIG. 6 illustrates a screen display of one exemplary method of automatically calculating the sum of all shipment quantities to ensure that it equals the total order quantity and alerting the user if not.

FIG. 7 illustrates a screen display of one exemplary method of modifying both production speed and shipping options, while automatically calculating and displaying the resulting price and estimated delivery date(s).

### DETAILED DESCRIPTION OF THE PREFERRED EMBODIMENTS

The present invention provides a system and method of dynamically modifying production speed, shipping method and/or shipping destination options for a custom-manufactured product order. The system and method in accordance with the present invention also allow customers to create split shipments from an original shipment and specify the quantity, shipping method and destination for each shipment. For any of or a combination of the possible modifications, the present invention also instantaneously calculates and displays an adjusted price and estimated delivery date(s), which is tentative until the customer or customer service representative submits the modifications.

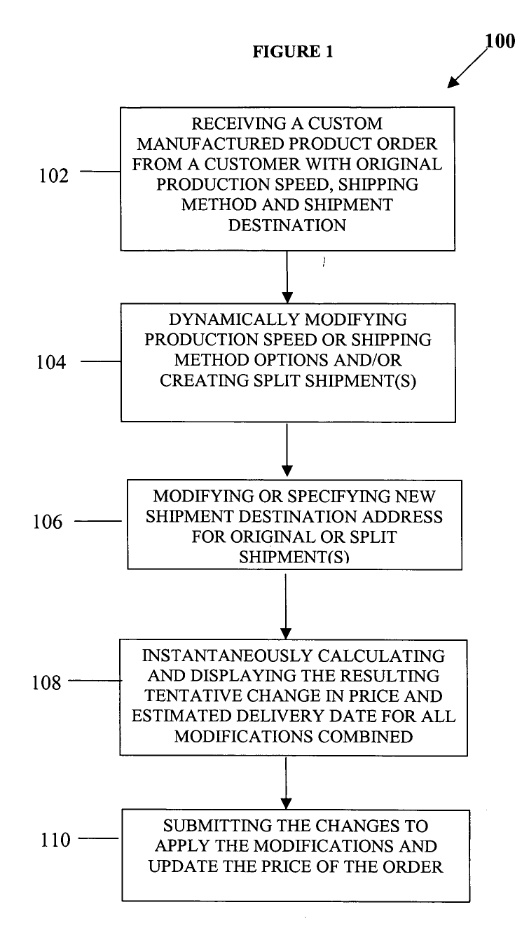

FIG. 1 illustrates a flow chart of one exemplary operation 100 of dynamically modifying delivery options of a custom-manufactured product order and automatically calculating the resulting prices and estimated delivery date(s). The operation 100 starts when a custom-manufactured product order is received (step 102 in FIG. 1). A customer specifies the production speed, shipping method and shipping destination when they place their order originally. The customer may later decide or request to modify the production speed or shipping method and/or create split shipments for the order (step 104 in FIG. 1). The customer may want to change the shipping destination address for the original shipment, or may need to specify or select an address for a new split shipment (step 106 in FIG. 1). An adjusted price for the modifications is instantaneously calculated and displayed for the customer, along with the estimated delivery date for each shipment (step 108 in FIG. 1). These modifications are tentative at this point, the customer or service representative may then choose to click a button to submit the changes and apply the modifications to the order (step 110 in FIG. 1).

In one example, a customer may order a total of 1,000 printed postcards, with originally one shipment and “normal” production speed for this product, which is 5 days. The customer then chooses to tentatively create a split shipment, so that 500 postcards are to be sent to Maine by UPS Ground shipping method, the remaining 500 are to be sent to California by UPS 2-Day shipping. In this example, the customer may also select “fast” production speed to increase the production speed to have the postcards produced in 4 days and receive the shipments one day earlier. The price for these changes is automatically calculated and displayed for the customer, but not automatically applied to the order unless the customer clicks on a button to Create a Split Shipment or Submit Changes. This allows the customer to see what the changes would cost before deciding to submit them.

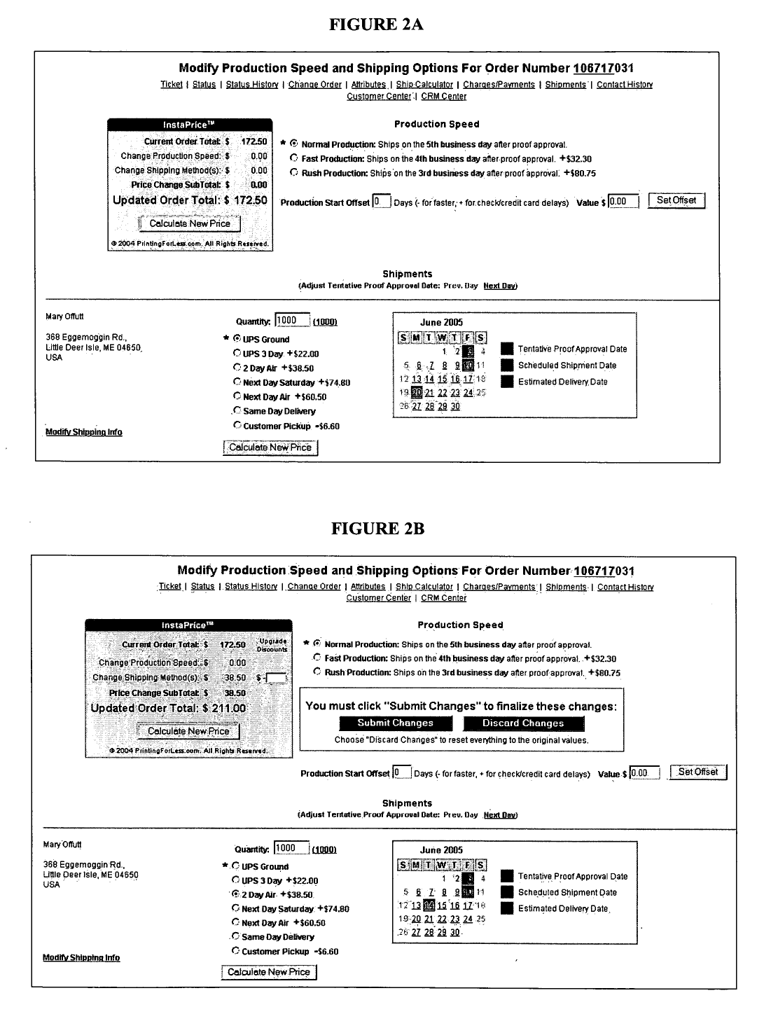

FIG. 2A illustrates a screen display before a shipping modification. FIG. 2B illustrates a screen display after a shipping modification. FIG. 2A shows the original customer order of 1000 postcard prints (with Order Number 106717031), with a production speed of “Normal Production—ships on the 5^{th} business day after proof approval” and a UPS Ground shipping method; a tentative proof approval date, a scheduled shipment date, and an estimated delivery date are color-highlighted in a calendar shown in FIG. 2A. When the customer simply selects a different shipping method, UPS 2-Day, and clicks the “Calculate New Price” button, an automatically adjusted price and estimated delivery date are instantaneously displayed, as shown in FIG. 2B. In this example, an additional $38.50 for change in shipping method increases the order total from $172.50 to $211.00, while the estimated delivery date changes from Jun. 20, 2005 to Jun. 14, 2005, as shown in FIGS. 2A and 2B.

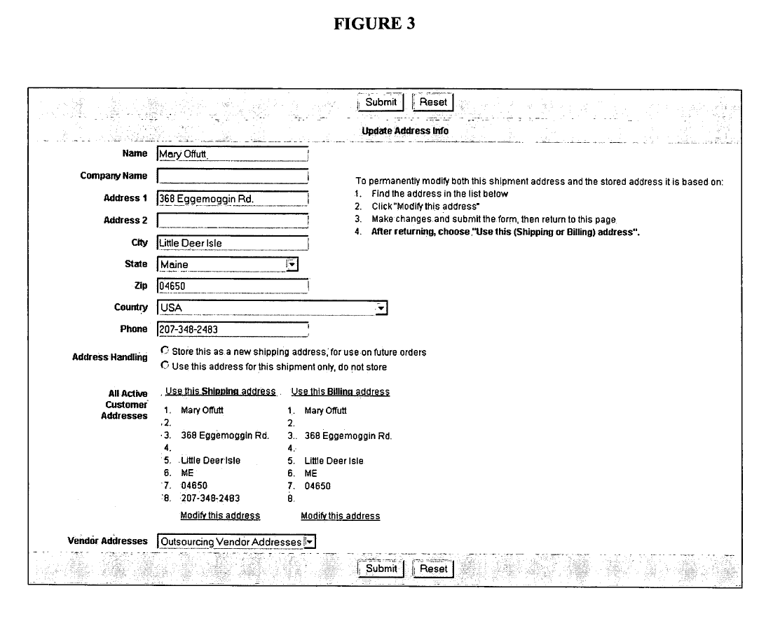

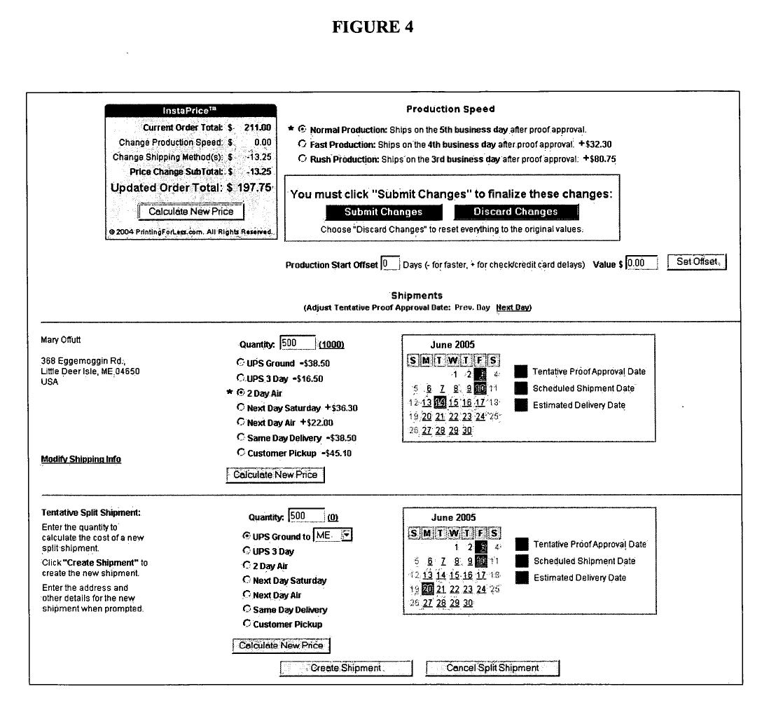

The customer may also modify the shipping destination address for the order, by clicking on the “Modify Shipping Info” link underneath the shipment address in FIG. 2B. FIG. 3 illustrates a screen display showing how the customer may update the address by either typing changes to the address or selecting from existing addresses in the customer's account The customer may choose to tentatively create a split shipment for the order to have part of the order sent to a different destination and/or via a different shipping method. FIG. 4 is a screen display that illustrates how a customer or service representative is able to dynamically input the quantity and select a shipping method for a tentative split shipment. In the example as shown in FIG. 4, when the customer input 500 for the new shipment quantity, the system automatically changed the original shipment quantity from 1000 to 500 postcard prints so that the total of the shipment quantities equals the total quantity of postcards ordered. The system also instantaneously displays the change in price, in this example adding a split shipment of 500 quantity with UPS Ground shipping results in a price decrease of $13.25 and adjusted tentative order total of $197.75 as shown in FIG. 4 ($13.25 less from $211.00 shown in FIG. 2B).

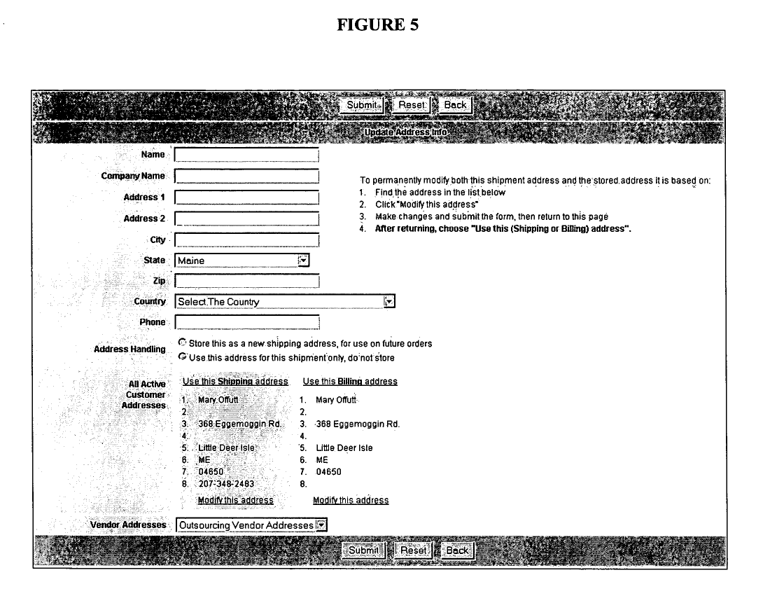

If the customer chooses to go forward with the split shipment, simply by clicking the “Create Shipment” button in FIG. 4, the modifications will be automatically applied to the order and the price updated. The system will then redirect the customer to the Update Address page in order to specify or select the shipping destination address for the new shipment, as illustrated in FIG. 5. Once the address is submitted, the previous page will show the new shipment and its estimated delivery date on the calendar.

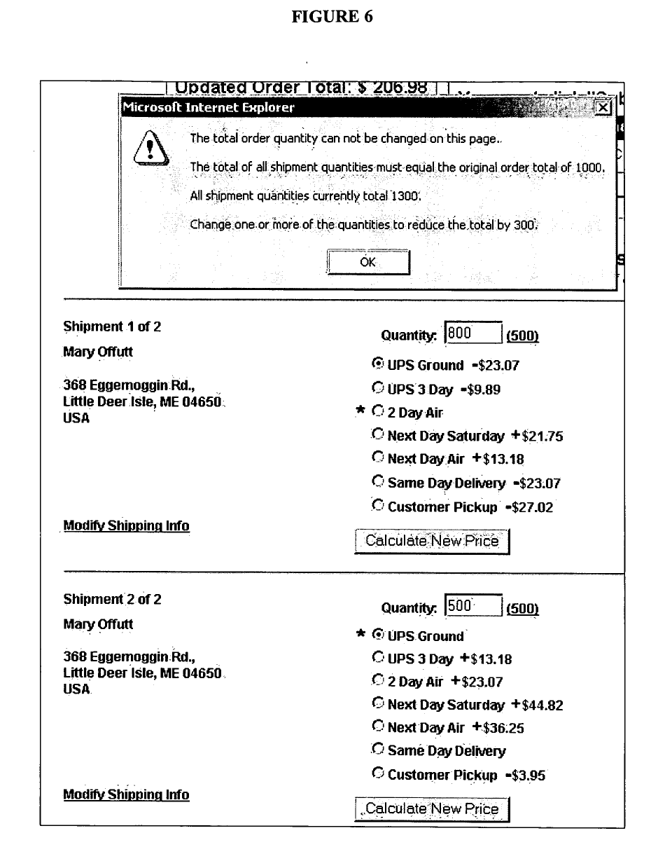

The customer may modify any of the shipments in the order, both the original and any split shipments. If there are multiple shipments for the order and the customer modifies the quantity of a shipment, the system automatically calculates the sum of the shipment quantities to ensure that the total quantity equals the total quantity ordered. If not, the system prevents the modifications from being applied and alerts the customer to correctly adjust shipment quantities, as shown in the screen display illustrated in FIG. 6.

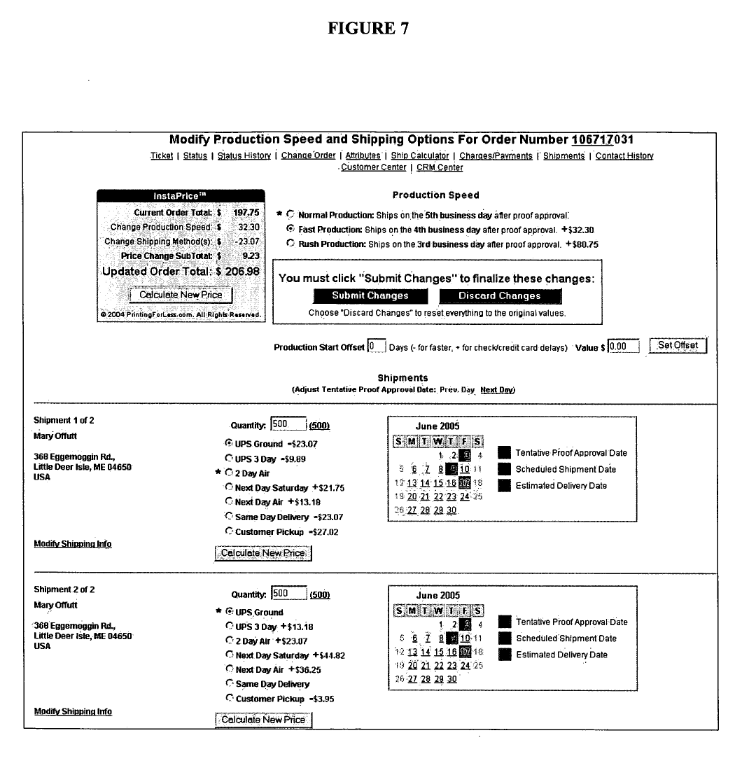

The customer may choose to modify both production speed and shipping options at the same time, or get the price for different options. FIG. 7 shows a customer selecting to tentatively change from “normal” to “fast” production speed and from 2-Day Air to UPS Ground for the first shipment. The system automatically calculates and instantaneously displays an increase of $32.30 for the change in production speed plus a decrease of $23.07 for the change in shipping method, combining for a price change subtotal of $9.23, resulting in an updated order total of $206.98, with a new estimated delivery date of Jun. 17, 2005 for the first shipment, as shown in FIG. 7. If the customer chooses to apply the modifications, he then simply clicks the “Submit Changes” button.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. References to details of particular embodiments are not intended to limit the scope of the invention.

What is claimed is:

1. A method of dynamically handling modification to production speed and shipment options for an original custom-manufactured product order, comprising:
providing the original custom-manufactured product order;
tentatively modifying at least one of production speed and/or shipment options from the original custom-manufactured product order; and
automatically calculating and displaying a resulting price and estimated delivery date with the modification before the modification is submitted.

2. A method of dynamically creating multiple shipments, which have at least one of differences in quantities, shipping methods and/or destinations, for an original custom-manufactured product order having production speed and shipment option, comprising:
providing the original custom-manufactured product order;
tentatively splitting the original custom-manufactured product order into multiple shipments for delivery by specifying quantities, shipping methods, and destinations of each shipment; and
automatically calculating and displaying a resulting price and estimated delivery date with the quantities, shipping methods, and destinations of each shipment before multiple shipments are submitted.

3. The method of claim 2, further comprising:
tentatively modifying at least one of production speed and/or shipment option from at least one of the multiple shipments; and
automatically calculating and displaying a resulting price and estimated delivery date with the modification before the modification is submitted.

4. A method of dynamically handling modification to production speed for an original custom-manufactured product order, comprising:
providing the original custom-manufactured product order;
tentatively modifying the production speed from the original custom-manufactured product order; and
automatically calculating and displaying a resulting price and estimated delivery date with the modification before the modification is submitted.

5. A method of dynamically handling modification to shipment option for an original custom-manufactured product order, comprising:
providing the original custom-manufactured product order;
tentatively modifying the shipment option from the original custom-manufactured product order; and
automatically calculating and displaying a resulting price and estimated delivery date with the modification before the modification is submitted.

6. The method of claim 5, wherein the shipment option includes quantities, shipping method, and shipping destination.

7. A method of dynamically handling modification to shipment quantities for an original custom-manufactured product order, comprising:
providing the original custom-manufactured product order;
tentatively modifying the shipment quantities from the original custom-manufactured product order; and
automatically calculating and displaying a resulting price and estimated delivery date with the modification before the modification is submitted.

8. A method of dynamically handling modification to a shipment method for an original custom-manufactured product order, comprising:
providing the original custom-manufactured product order;
tentatively modifying the shipment method from the original custom-manufactured product order; and
automatically calculating and displaying a resulting price and estimated delivery date with the modification before the modification is submitted.

9. A method of dynamically handling modification to shipment destination for an original custom-manufactured product order, comprising:
providing the original custom-manufactured product order;
tentatively modifying the shipment destination from the original custom-manufactured product order; and
automatically calculating and displaying a resulting price and estimated delivery date with the modification before the modification is submitted.
